(19) United States
(12) Patent Application Publication
(10) Pub. No.: US 2006/0201537 A1
(43) Pub. Date: Sep. 14, 2006

(54) Method for cleaning articles in a dish washing machine

(76) Inventors: Werner Strothoff, Sassenberg Fuchtorf (DE); Winfried Troll, Düsseldorf (DE); Gerold Carlhoff, Tonisvorst (DE)

Correspondence Address: SKANA ENTERPRISES CORP., 4915 CHISHOLM STREET, DELTA, BC, V4K 2K6, CA

(21) Appl. No.: 10/554,641

(22) PCT Filed: May 6, 2004
(86) PCT No.: PCT/EP04/04831

§ 371 Date: Nov. 23, 2005

(30) Foreign Application Priority Data
May 13, 2003 (EP) 03010676.9

(51) Int. Cl. B08B 7/00

(52) U.S. Cl. 134/42

(57) ABSTRACT

The invention concerns a method for cleaning articles in a dish washing machine comprising an alkaline and an acidic cleaning step and at least one additional alkaline cleaning step, characterized in that a) in a hood dish washing machine there is a first alkaline cleaning step with an aqueous cleaning solution having a pH-value higher than 9, b) the first alkaline cleaning step is followed by a first acidic cleaning step with an aqueous cleaning solution having a pH-value lower than 5. c) the first acidic cleaning step is followed by at least a second alkaline cleaning step with an aqueous cleaning solution having a pH-value higher than 9.

The invention relates to a method for cleaning articles in a dish washing machine comprising an alkaline and an acidic cleaning step and at least one additional alkaline cleaning step.

The invention also relates to a hood dish washing machine with a rinse arm for spraying a rinse solution and with a spray arm for spraying an alkaline cleaning solution, connected to a reservoir for the alkaline cleaning solution.

Dish washing machines, especially industrial dish washing machines, primarily used in catering departments, are long known and are based on the idea of spraying a mixture of washing water and a cleaning agent towards the articles to be washed. In hood dish washing machines the articles to be washed are fixed in a suitable device in the washing compartment. The washing process is begun by a pump pumping washing water. When the washing water has attained a suitable pressure and flow a cleaning agent is added by the pump drawing a mixture of washing water and a cleaning agent from a magazine. After washing, the articles are rinsed with fresh water to which a minor amount of a rinsing agent or a drying agent can be added.

Besides this kind of hood dish washing machines there are also industrial dish washing machines in which the articles to be washed or cleaned are transported through the machine during the washing cycle and the articles are sub-sequentially sprayed with cleaning or washing solutions at different places within the washing machine.

A special problem in the area of dish washing is to clean articles in commercially available dishwashers wherein primarily starch deposits are to be removed from the articles. WO 02/100993 A1 discloses a cleaning method in accordance with the preamble of claim 1. This cleaning method comprises an alkaline and an acidic cleaning step in addition to one or several other alkaline and/or acidic cleaning steps, especially for washing dishes in commercially available dish washers, wherein primarily starch deposits are removed in an excellent manner. This known method is disclosed to be used in dishwashers in which the articles to be cleaned are transported during the cleaning cycle. As the articles are transported the method can be easily realized because the different cleaning steps can be performed at different places within the dish washer by nozzles or the like which are placed one behind the other in the transport way of the transported articles. WO 02/100993 A1, however, does not give any indication whether such a method could also be used in a hood dish washing machine successfully and in which way such a method could be performed in a hood dish washing machine.

Therefore it is an object of the invention to find a solution by which primarily starch deposits can be removed in an excellent manner in hood dish washing machines.

This object is reached by the method of claim 1.

It has been surprisingly found out that even in hood dish washing machines excellent results can be reached for removing starch deposits on articles. Surprisingly even excellent results were obtained with low concentration of acid. It has been found that at least three cleaning steps are necessary. The first and the third cleaning steps are with an aqueous cleaning solution having a pH-value higher than 9 and the middle cleaning step is a cleaning step with an acidic cleaning solution having a pH-value lower than 5. For most applications these three cleaning steps are sufficient. All cleaning solutions are sub-sequentially sprayed on the articles in the hood dish washing machine.

In some cases it is advantageous that the second alkaline cleaning step is followed by a second acidic cleaning step and the second acidic, cleaning step is followed by a third alkaline cleaning step. If necessary even more cleaning steps can be performed.

In normal hood dish washing machines it is usual that the rinse solution is sprayed over the articles by a rinse arm of the hood dish washing machine. Therefore it is advantageous that the acidic cleaning solution is also sprayed over the articles.

For spraying the acidic cleaning solutions the solution can be sprayed by the rinse arm of the machine, by a second additional rinse arm or by additional nozzles, which are installed in the interior of the dish washing machine.

Moreover it is advantageous that between the successive cleaning steps there is always a pause and that after the last cleaning step a rinse step is performed. So the program of the machine is modified from a three-step process (alkaline step, pause, rinse step) to at least a seven-step process (alkaline step, pause, acidic step, pause, second alkaline step, pause, rinse step).

To solve the above-mentioned object the invention also relates to a hood dish washing machine with a rinse arm for spraying a rinse solution and a spray arm for spraying an alkaline cleaning solution, connected Lo a reservoir for the alkaline cleaning solution characterized by means for spraying an acidic cleaning solution.

The means for spraying the acidic cleaning solution can be realized as follows:

Especially for hood dish washing machines, which are already in use, it is advantageous that the means for spraying the acidic cleaning solution is the rinse arm being optionally connected to the reservoir for the rinse solution or the reservoir for the acidic cleaning solution.

Alternatively the means for spraying the acidic cleaning solution is the rinse arm having additional nozzles for the acidic cleaning solution.

Alternatively and/or additionally the means for spraying the acidic cleaning solution comprises nozzles being installed in the interior of the machine, especially in the top and bottom area.

It can also be foreseen that the means for spraying the acidic solution comprises an additional rinse arm.

Embodiments of the invention will be described in more detail below with reference to the accompanying drawings, in which

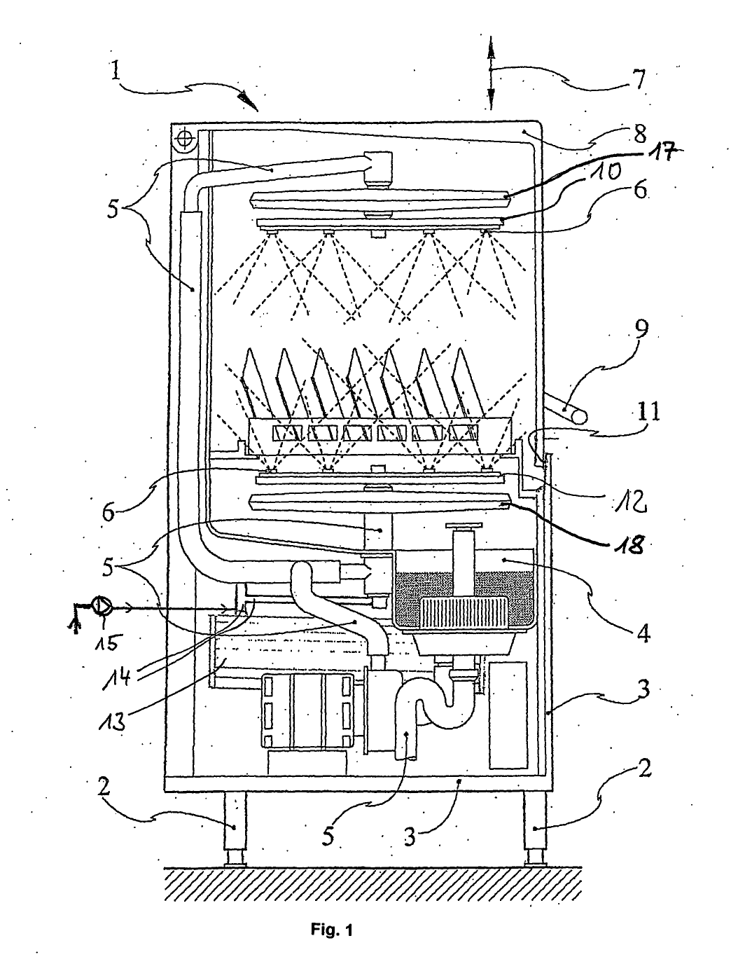

FIG. 1 shows schematically a hood dishwashing machine according to a first embodiment,

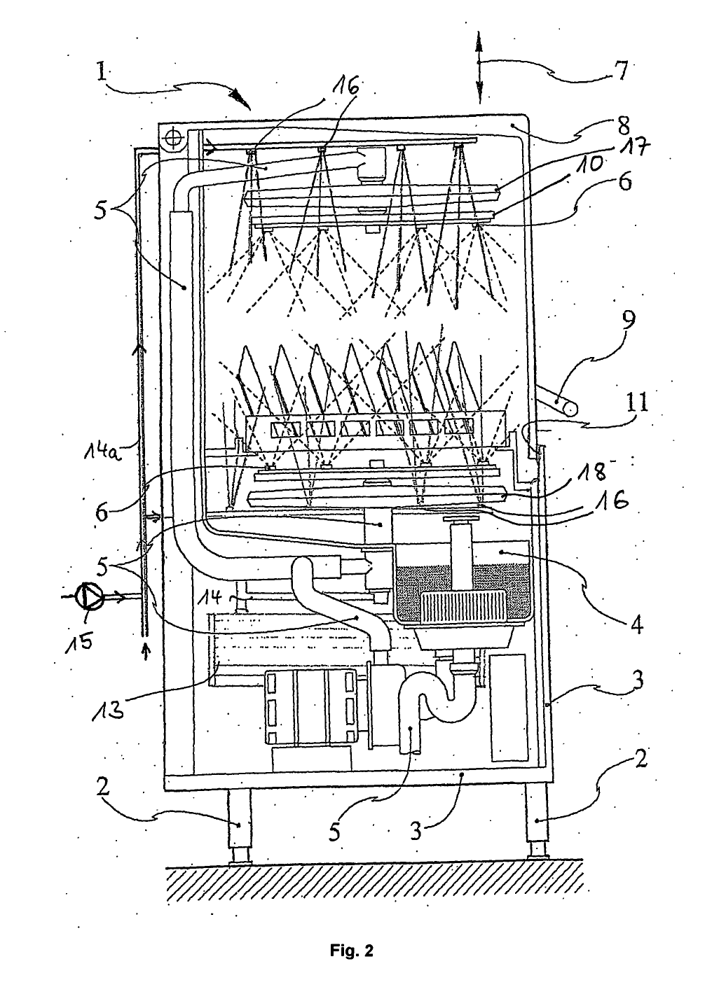

FIG. 2 shows a hood dish washing machine according to a second embodiment,

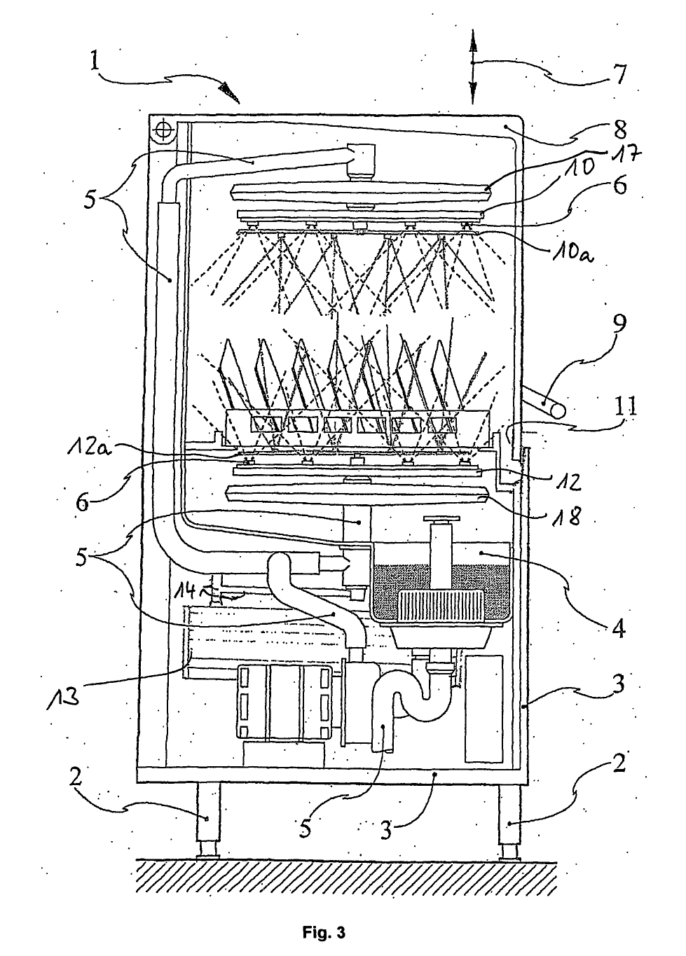

FIG. 3 shows a hood dish washing machine according to a third embodiment and

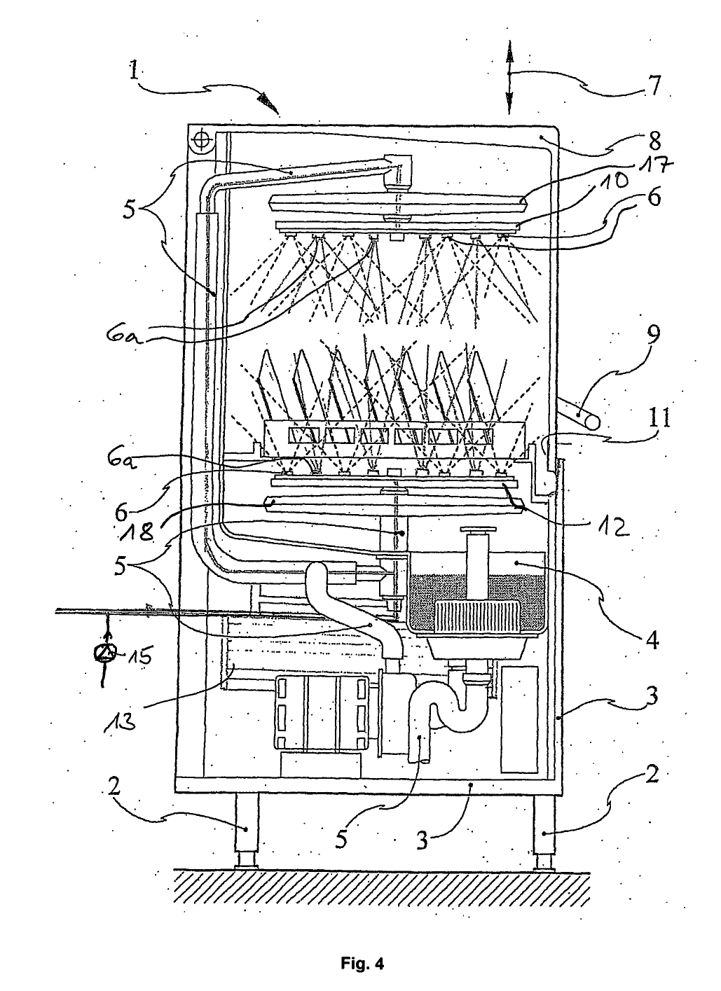

FIG. 4 shows a hood dish washing machine according to a fourth embodiment.

The figures show, in schematic sectional illustration, in each instance a commercial hood dish washing machine 1 which has principally the same structure. Therefore in all figures the same reference numbers are used for identical parts.

In its lower part the hood dish washing machine 1 consists of a housing frame part 3 provided with support legs 2. In the housing frame part 3 there is arranged a first tank 4 for an alkaline cleaning solution. This alkaline cleaning solution is sucked out of the tank 4 a pump (not shown), fed by means of pipe ducts 5 under pressure to spray nozzles 6 of an upper spray arm 17 and a lower spray arm 18 and sprayed onto the dishes disposed in the upper part of the hood dish washing machine 1. After a pause heated rinse water from a boiler 13 is sprayed over an upper rinse arm 10 and a lower rinse arm 12. In order to be able to introduce soiled dishes into the dish washing machine 1 and remove cleaned dishes again from the dish washing machine 1 the dish washing machine 1 has in its upper part a door pivotable in the direction of the arrow 7 or a pivotable housing part 8. This pivotable housing part 8 is to be pivoted by means of a handgrip 9 by the user upwardly for opening and downwardly again for closing into the position illustrated in the figures. In an area 11 the pivotable housing part 8 overlaps the housing frame part in closed position.

According to the embodiment of FIG. 1 the boiler 13 is connected to the rinse arms 10, 12 by additional pipe ducts 14. Acid from a container (not shown) can he pumped with a pump 15. Via this pipe ducts 14 and the pump 15 acidic cleaning solution and water from boiler 13 can be transported to the nozzles 6 of the rinse arms 10 and 12. The rinse arms 10 and 12 and all the pipes 14 are so constructed that the rinse arms 10, 12 are optionally connected only to the boiler 13 for rinsing or to the boiler 13 and the pump 15 for the acidic cleaning solution. So it is possible to alternatively spray rinse water or acidic cleaning solution on the dishes.

FIG. 2 shows an embodiment, which differs from the one shown in FIG. 1 by the fact that additional nozzles 16 in the top and the bottom area of the dish washing machine 1 above and beneath the spray arms 17, 18 are mounted. These nozzles 16 are connected to the pump 15 via a further pipe ducts 14a (diluted with water). In this way it is possible to spray the acidic cleaning solution over the nozzles 16.

FIG. 3 shows a further embodiment of a hood dishwashing machine 1. In this case the boiler 13 is not connected to rinse arms 10 and 12 but to additional rinse arms 10a and 12a. The additional upper rinse arm 10a is arranged close to the rinse arm 10 and the additional lower rinse arm 12a close to the lower rinse arm 12. These additional rinse arms 10a, 12a are connected with the boiler 13 and the pump (not shown).

In this case the alkaline cleaning solution from tank 4 is sprayed over spray arms 17 and 18 whereby the acidic cleaning solution is sprayed over the additional rinse arms 10a, 12a and the rinse solution over the rinse arms 10 and 12.

FIG. 4 shows another embodiment, which is similar to the one of FIG. 3. In this case, however, no additional rinse arms are foreseen but the rinse arms 10, 12 are equipped with additional nozzles 6a, which are connected with a water supply and the pump 15. The other nozzles 6 are connected with the boiler 13.

It is apparent that in this case the rinse solution is sprayed over nozzles 6 of rinse arms 10, 12 and the acidic cleaning solution over nozzles 6a.

### EXAMPLES

A standard hood dish washing machine (Krefft Professional Plus) was modified in that way that an additional injection point was added to the rinse cycle. The program of the machine was modified from alkaline cleaning, pause and rinse step, to alkaline cleaning, pause, acidic rinse, pause, alkaline cleaning.

The results of the test are shown in the following table. 0 means no cleaning effect, 10 means perfect clean. Test soil was black colored, starch. The temperature of the machine was 60° C.; rinse 75° C. Test 1 to 4 has been carried out with softened water, Test 5 and 6 with hard water (16° dH). Test 5 and 6 has been carried out as a 2-cycle test.

| | | pause in | | pause in | alkaline | | overall | |
|---|---|---|---|---|---|---|---|---|
| No. | alkaline step 1 | sec. | acidic step | sec. | step 2 | Result | time | |
| 1 | 1 min | 10 | 3,3 1 water | 30 | 2 min | 3/5 | 2.50 | min |
| | 3 g/l | | (blind test) | | 3 g/l | | | |
| | Perclin | | | | Perclin | | | |
| | Intensiv fl. | | | | Intensiv fl. | | | |
| 2 | 1 min | 10 | 3,3 3 | 30 | 2 min | 9/9 | 2.50 | min |
| | 3 g/l | | 0.25% | | 3 g/l | | | |
| | Perclin | | H3PO4 | | Perclin | | | |
| | Intensiv fl. | | | | Intensiv fl. | | | |
| 3 | 1 min | 10 | 3,3 1 | 30 | 2 min | 9/9 | 2.50 | min |
| | 3 g/l | | 0.25% | | 3 g/l | | | |
| | Perclin | | H3PO4 | | Perclin | | | |
| | Intensiv fl. | | | | Intensiv fl. | | | |
| 4 | 1 min | 10 | 3,3 1 | 30 | 2 min | 9/9 | 2.50 | min |
| | 3 g/l | | 0.08% | | 3 g/l | | | |
| | Perclin | | HNO3 | | Perclin | | | |
| | Intensiv fl. | | | | Intensiv fl. | | | |
| 5 | 16 sec. | 4 | 7 sec | 10 | 16 sec | 7/7 | 2 × 53 | sec |
| | 3 g/l | | (2,75 1) | | 3 g/l | | | |
| | Perclin | | 0.18% | | Perclin | | | |
| | Intensiv fl. | | H3PO4 | | Intensiv fl. | | | |
| 6 | 16 sec. | 4 | 7 sec | 10 | 16 sec | 1/0 | 2 × 53 | sec |
| | 3 g/l | | (2,75 1) | | 3 g/l | | | |
| | Perclin | | water | | Perclin | | | |
| | Intensiv fl. | | (blind test) | | Intensiv fl. | | | |

1-11. (canceled)

12. A method for cleaning articles in a hood dishwashing machine, the hood dishwashing machine comprising a rinse arm and a spray arm connected to a reservoir of alkaline cleaning solution, the method comprising:
a) washing the articles in a first alkaline cleaning step with an alkaline cleaning solution having a pH-value higher than 9, the alkaline cleaning solution being distributed by the spray arm;
b) pausing;
c) washing the articles in a first acidic cleaning step with an acidic cleaning solution having a pH-value lower than 5, the acidic cleaning solution being distributed by the rinse arm;
d) pausing;
e) washing the articles in a second alkaline cleaning step with an alkaline cleaning solution having a pH-valve higher than 9, the alkaline cleaning solution being distributed by the spray arm;
f) pausing; and
g) rinsing the articles in a rinse step with water or an aqueous rinse solution, the water or aqueous rinse solution being distributed by the rinse arm.

13. The method according to claim 12, further comprising washing the articles in a second acidic cleaning step, pausing, and washing the articles in a third alkaline cleaning step after the third pause and prior to the rinse step.

14. The method according to claim 13, further comprising more than one additional sequence of washing the articles in an acidic cleaning step, pausing, and washing the articles in an alkaline cleaning step after the third pause and prior to the rinse step.

15. A hood dishwashing machine comprising:
a) a rinse arm for spraying a rinse solution;
b) a spray arm for spraying a cleaning solution;
c) a reservoir of alkaline cleaning solution connected to the spray arm; and
d) an acidic cleaning solution connected to the rinse arm wherein the rinse arm is connected to a boiler for rinsing and a pump.
